(19) United States
(12) Patent Application Publication
(10) Pub. No.: US 2014/0189855 A1
(43) Pub. Date: Jul. 3, 2014

(54) Gestures for Unlocking a Mobile Device

(71) Applicants: Yaaron Moradi, Kfar Sava (IL); Suriel Ben Dahan, Efrat (IL); Mordechai Teicher, Hod Hasharon (IL)

(72) Inventors: Yaaron Moradi, Kfar Sava (IL); Suriel Ben Dahan, Efrat (IL); Mordechai Teicher, Hod Hasharon (IL)

(73) Assignee: CONDUIT, LTD., Ness Ziona (IL)

(21) Appl. No.: 14/072,866

(22) Filed: Nov. 6, 2013

Related U.S. Application Data
(60) Provisional application No. 61/747,645, filed on Dec. 31, 2012.

(51) Int. Cl. G06F 21/36; G06F 3/0488

(52) U.S. Cl. CPC G06F 21/36; G06F 3/0488
USPC 726/19; 715/863

(57) ABSTRACT

Methods for recognition and interpretation of pinch-in and pinch-out gestures for unlocking a screen of a mobile device, which has been locked to prevent accidental activation of device functionalities while being carried, such as in pocket or purse.

### CROSS REFERENCE TO RELATED APPLICATIONS

This application claims benefit of U.S. Provisional Patent Application Ser. No. 61/747,645, filed Dec. 31, 2012, the disclosure of which is hereby incorporated herein by reference, and the priority of which is hereby claimed pursuant to 37 CFR 1.78(a) (4) and (5)(i).

### BACKGROUND

1. Field

The present invention relates to mobile devices with touch screens, and in particular to gestures for unlocking locked mobile devices.

2. Description of Related Art

Mobile devices are carried in pockets, briefcases and handbags of users. Many devices feature a touch screen that is sensitive to pressure, and which is exposed to accidental touches that may cause inadvertent operations such as dialing, playing a song, or launching an application that consumes data or drains the device's battery. A common approach for protecting a mobile device with a touch screen against inadvertent operations is the so-called “locked screen”, which does not respond to accidental touches and requires a predefined gesture that is unlikely to occur accidentally in pocket or purse, in order to enter the unlocked state. Typically, a mobile device defaults into locked screen status after a few moments of inactivity, or in response to an explicit user command such as pressing a device's lock button.

There is a need to offer more convenience and functionalities to lock and unlock screens. This need is met by embodiments of the present invention.

### SUMMARY

Embodiments of the invention provide recognition and interpretation for additional and more convenient gestures for locking and unlocking a screen of a mobile device.

Therefore, there is provided by an embodiment of the present invention a method for unlocking a mobile device having a touch screen, the method including: (a) displaying on the touch screen a preview version of a content; (b) detecting and interpreting a gesture entered at the touch screen; and (c) if the interpreted gesture is a pinch-out gesture, then replacing the preview version of the content with a full interactive version of the content.

In addition, there is also provided by another embodiment of the present invention a method for unlocking a mobile device having a touch screen, the method including: (a) detecting and interpreting a gesture entered at the touch screen; and (b) if the interpreted gesture is a pinch-in gesture, then unlocking the mobile device.

### BRIEF DESCRIPTION OF THE DRAWINGS

The disclosed subject matter may best be understood by reference to the following detailed description when read with the accompanying drawings in which:

FIG. 1 illustrates an exemplary embodiment of a touch screen.

FIG. 2 illustrates a pinch-out gesture on a device screen.

FIG. 3 illustrates the result of receiving and interpreting the pinch-out gesture of FIG. 2.

FIG. 4 illustrates a pinch-in gesture on a device screen.

FIG. 5 illustrates a display of a home screen including icons.

FIG. 6 illustrates a display of a security screen.

FIG. 7 is a flowchart of a method according to an embodiment of the present invention.

### DETAILED DESCRIPTION

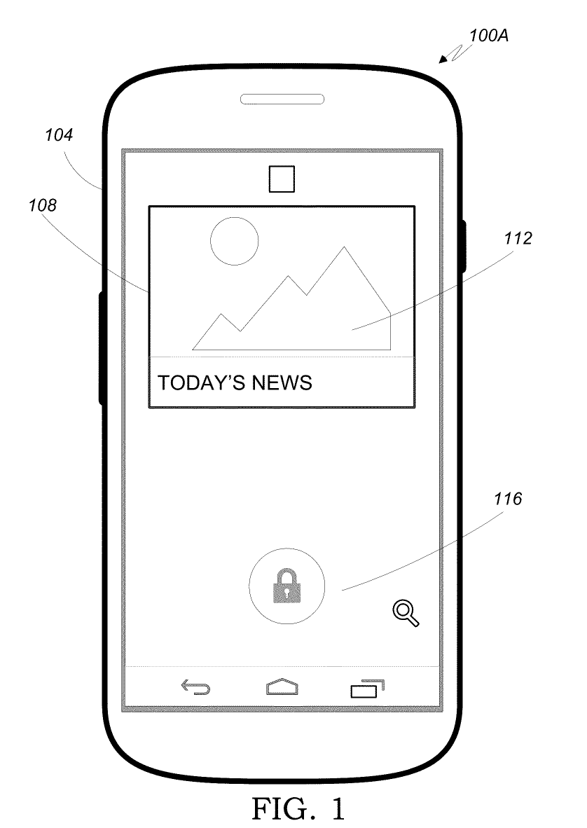

Reference is made to FIG. 1, which describes an exemplary embodiment of a touch screen according to the present disclosure. A state 100A is that of a mobile device 104 in locked mode, wherein a content window 108 shows a content preview 112 that includes graphics, text, and/or animated elements downloaded via the Internet, such as news or weather; and/or content generated by mobile device 104, such as calendar information or a game status; and/or is a display of mobile device widgets. An optional standard screen part 116 includes visual and functional elements that are common in mobile device lockable screens, such as unlock graphics, a clock, and alerts.

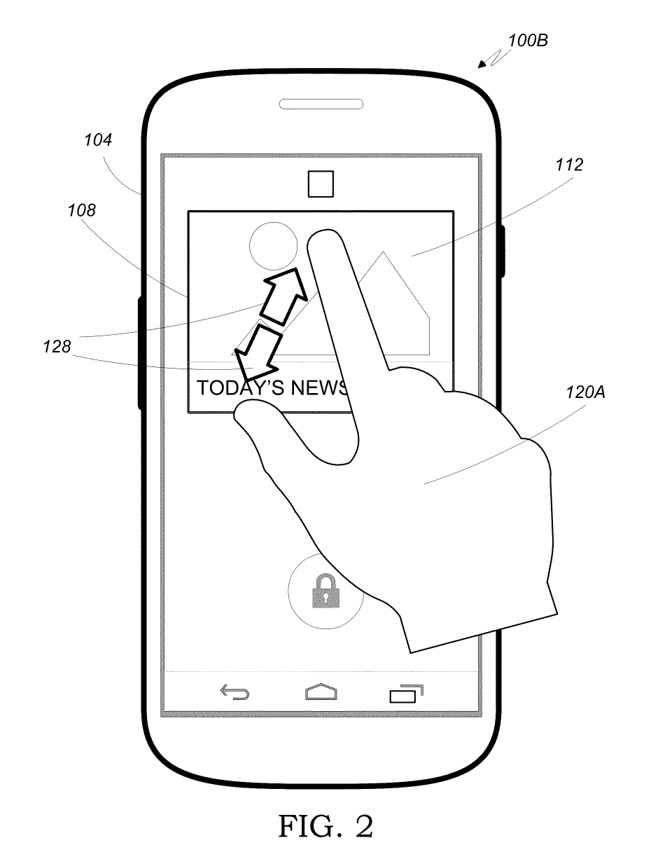

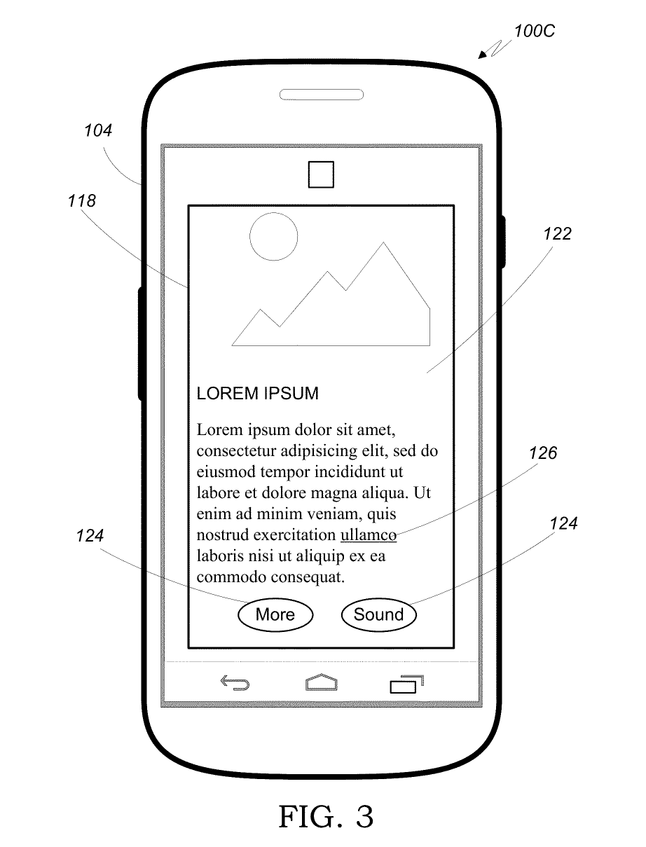

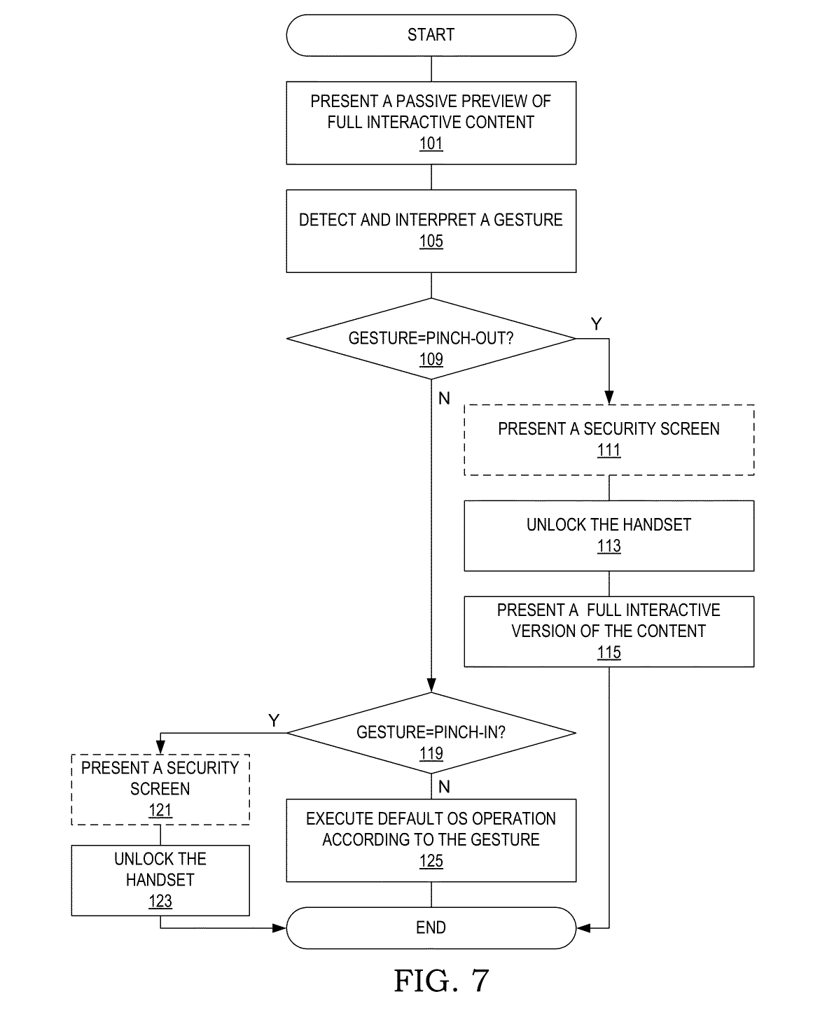

FIG. 2 illustrates a state 100B of mobile device 104, in which mobile device 104 is receiving a pinch-out gesture from a user's hand 120A, such that two fingers simultaneously touch the screen and move away from each other. Arrows 128 depict the direction of the fingers' motion, and are not part of the screen display. Although a typical user may instinctively apply the pinch-out gesture within or next to content window 108 displaying content preview 112, a pinch-out gesture in other parts of the screen may also be programmed to have a similar effect, depending on design considerations. The pinch-out gesture of FIG. 2 is identified by mobile device 104 and is interpreted and responded to, as described with reference to FIGS. 3 and 7 below.

FIG. 3 illustrates a state 100C of mobile device 104, in which mobile device 104 has interpreted and is responding to the pinch-out gesture of FIG. 2. In response to the pinch-out gesture of FIG. 2 being received and interpreted, the mobile device unlocks and then presents full interactive content 122 corresponding to content preview 112, for example by automatically launching an interactive mobile app or downloading a webpage associated with the specific content presented in the content window 108 prior to the pinch-out gesture of FIG. 2. The screen, and optionally also a speaker (not shown) of mobile device 104, exhibit full interactive content 122 that corresponds to content preview 112 of FIG. 2, thereby providing a seamless transition from preview mode to full interactive mode following the user's pinch-out gesture. In the full interactive mode, full interactive content 122 may, in non-limiting example, include video, audio, and interactive elements such as links indicated by a hot link 126, and active buttons such as buttons 124, which selectably trigger actions such as “more” for scrolling to the next page, or “sound” for turning audio on and off.

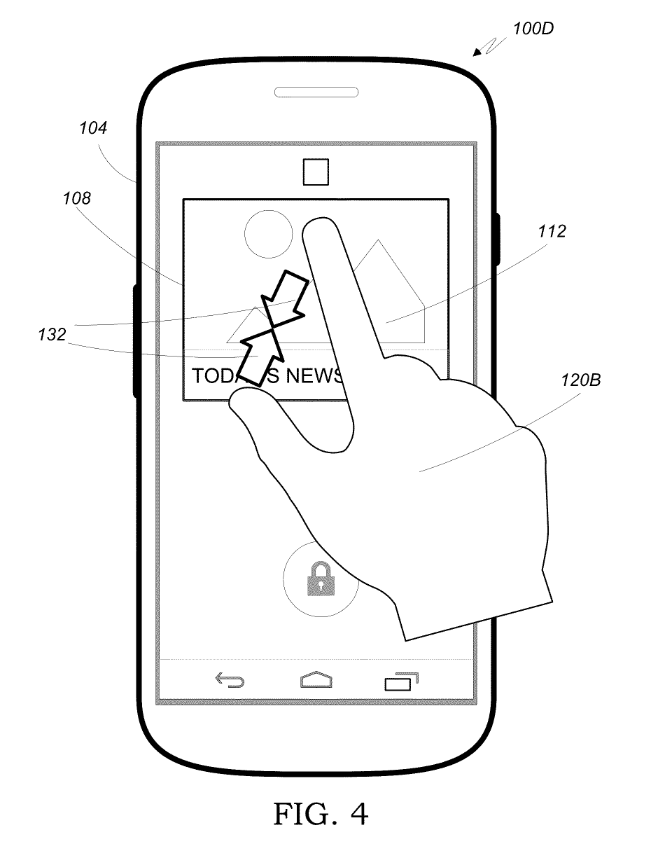

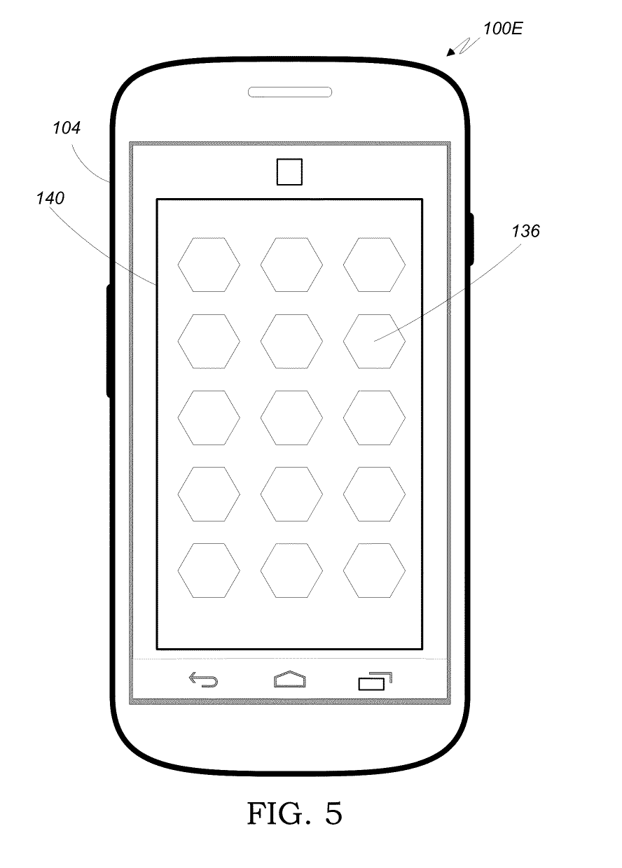

FIG. 4 illustrates a state 100D of mobile device 104, in which mobile device 104 of FIG. 1 is receiving a pinch-in gesture from a user's hand 120B, where two fingers touch the screen simultaneously and move toward each other. Arrows 132 depict the direction of the fingers' motion, and are not part of the screen display. Although a typical user may instinctively apply the pinch-in gesture within or next to content window 108 displaying content preview 112, a pinch-in gesture in other parts of the screen may also be programmed to have a similar effect, depending on design considerations. The pinch-in gesture of FIG. 4 is identified by mobile device 104 and is interpreted and responded to as described with reference to FIGS. 5 and 7 below.

FIG. 5 illustrates a state 100E of mobile device 104, in which the display of mobile device 104 shows a home screen 140, which is a conventional home screen including a plurality of icons, such as an icon 136, each acting as a button for activating an application or functionality of mobile device 104, or as a link to a webpage accessible via the Internet. Thus, in the context of the present disclosure, FIG. 5 illustrates how mobile device 104 moves to a typical unlock state 100E, following a pinch-in gesture (FIG. 4).

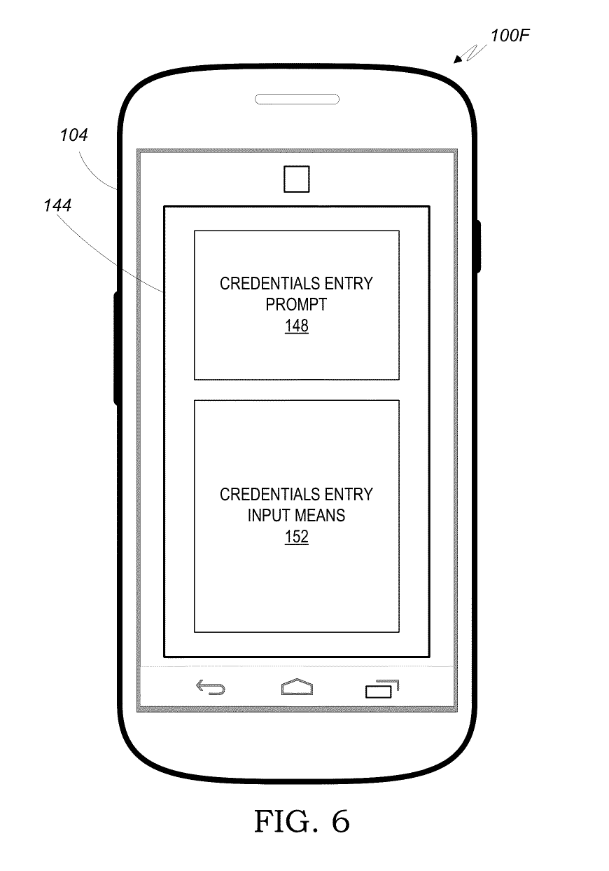

FIG. 6 illustrates an optional state 100F of mobile device 104 according to embodiments of the present invention which provide a security feature. In state 100F mobile device 104 requires the user to enter personal credentials, such as a password, secret gesture, or biometric signature such as a voice or a face image, in order to access the functionalities of mobile device 104. Thus, in certain embodiments of the invention, the pinch-out gesture of FIG. 2 or the pinch-in gesture of FIG. 4 leads to an intermediate security screen 144 (shown in a non-limiting example), where, for example, the user is faced with a credentials entry prompt 148, directing the user to respond by entering personal credentials via credentials entry input means 152 such as a keypad for entering a password, a touchscreen area for entering a personal secret gesture, a microphone for entering the user's voice for analysis, or a camera for acquiring a face image of the user for recognition. In these embodiments, successful recognition of the user through the entered credentials is a precondition for mobile device 104 to pass into state 100C (FIG. 3) or state 100E (FIG. 5).

FIG. 7 is a flowchart of a method according to an embodiment of the present invention. In a step 101, a content preview 112 of full interactive content 122 is shown on the screen of mobile device 104. The term “interactive content” herein denotes content that includes active user-input elements such as buttons and links Interactive content may also include streaming video and sound. The term “preview” herein denotes a purposely-degraded version of the interactive content which is adapted to a locked screen state, such as by disabling active input elements, muting sound, and preferably avoiding streaming video to reduce data plan usage and battery drain.

In a step 105, mobile device 104 receives and interprets a gesture sensed by the touchscreen. If, at a decision point 109, the gesture is interpreted as a pinch-out gesture (FIG. 2), then, if a security feature is included in mobile device 104, a security screen (FIG. 6) is presented in a step 111, and only upon passing the security check does the method continue toward a step 113. In step 113 mobile device 104 unlocks, and in a step 115 the mobile device presents full interactive content 122 (FIG. 3), to replace content preview 112 (FIG. 1), such as by automatically launching a respective mobile app or downloading a respective interactive webpage. If step 105 detects and interprets a pinch-in gesture, then following a step 119, the handset unlocks in a step 123, (and if security is enabled, also only after successfully passing security check in a step 121, similar to step 111 above). If, after steps 109 and 119 the gesture detected and interpreted in step 105 is found to be neither a pinch-out gesture nor a pinch-in gesture, then in a step 125 the gesture of step 105 is handed over to the operating system of mobile device 104 for executing a default operation of the operating system according to the gesture (the default operation may be null).

According to certain embodiments of the invention, as illustrated in FIG. 7, a pinch-out gesture identified in step 109 leads to both unlocking the handset in step 113 and to presenting a full version of the content in step 115 (i.e. providing access to all functionalities of mobile device 104). In other embodiments, however, step 113 is omitted, such that step 115 is executed to provide full interactive content 122 without allowing access to other functionalities of mobile device 104, thereby requiring another unlock action, such as the pinch-in gesture of FIG. 4, in order to access other functionalities of mobile device 104 beyond interaction with full interactive content 122 (FIG. 3), as provided by step 115.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A method for unlocking a mobile device having a touch screen, the method comprising:
displaying on the touch screen a preview version of a content;
detecting and interpreting a gesture entered at the touch screen; and
if the interpreted gesture is a pinch-out gesture, then replacing the preview version of the content with a full interactive version of the content.

2. The method of claim 1, wherein, if the interpreted gesture is a pinch-out gesture, then also unlocking the mobile device for allowing access to all functionalities of the mobile device.

3. The method of claim 1, further comprising passing a security check as a condition for said replacing.

4. The method of claim 1, further comprising:
if the interpreted gesture is a pinch-in gesture, then unlocking the mobile device and displaying a home screen of the mobile device.

5. The method of claim 4, further comprising: passing a security check as a condition for said unlocking.

6. A method for unlocking a mobile device having a touch screen, the method comprising:
detecting and interpreting a gesture entered at the touch screen; and
if the interpreted gesture is a pinch-in gesture, then unlocking the mobile device.

7. The method of claim 6, further comprising: passing a security check as a condition for said unlocking.

8. The method of claim 6, further comprising:
displaying on the touch screen a preview version of a content; and
if the interpreted gesture is a pinch-out gesture, then replacing the preview version of the content with a full interactive version of the content.

9. The method of claim 8, further comprising: passing a security check as a condition for said replacing.

10. The method of claim 8, wherein, if the interpreted gesture is a pinch-out gesture, then also unlocking the mobile device for allowing access to all functionalities of the mobile device.
